(19) United States
(12) Patent Application Publication
(10) Pub. No.: US 2018/0238238 A1
(43) Pub. Date: Aug. 23, 2018

(54) ANNULAR SURFACE COOLER AND METHOD OF FORMING MULTIPLE FINS IN A HEAT EXCHANGER

(71) Applicant: UNISON INDUSTRIES, LLC, Jacksonville, FL (US)

(72) Inventors: Bernard Albert Luschek, Lebanon, OH (US); Derek Thomas Dreischarf, Bellbrook, OH (US); Dennis Alan McQueen, Miamisburg, OH (US); Michael Ralph Storage, Centerville, OH (US)

(21) Appl. No.: 15/440,551

(22) Filed: Feb. 23, 2017

(51) Int. Cl. F02C 7/18; F28D 1/047; F28F 1/26; B21D 53/02; F02K 3/06

(52) U.S. Cl. CPC F02C 7/18; F28D 1/0471; F28D 2021/0021; B21D 53/022; F02K 3/06; F28F 1/26

(57) ABSTRACT

A method of forming fins in a heat exchanger includes using a stacked slit saw with multiple saw blades to simultaneously cut multiple fins into a metal body of the heat exchanger, with each fin having a body extending from an upper surface of the metal body and terminating in a tip.

### BACKGROUND OF THE INVENTION

Contemporary engines used in aircraft can produce substantial amounts of heat needing to be transferred away from the engine. Heat exchangers provide a way to transfer heat away from such engines. For example, one type of heat exchanger that may be used is an annular surface cooler that is mounted to an aft fan casing. Integral fins formed from parent material in the heat exchanger can have a significantly higher heat transfer coefficient versus fins which may be brazed or otherwise attached to the parent material. The fins of such heat exchangers provide large surface areas required for transferring heat to the surrounding air.

### BRIEF DESCRIPTION OF THE INVENTION

In one aspect, the present disclosure relates to a method of forming multiple fins in a heat exchanger which includes providing a metal body having an upper surface and including fluid cooling passages, where the body includes a layer of metal along the upper surface and spaced from the fluid cooling passages, and cutting the layer of metal to simultaneously form a plurality of fins with each fin having a body extending from the upper surface and terminating in a tip.

In another aspect, the present disclosure relates to a method of forming multiple fins in a portion of a surface cooler for an aircraft engine which includes providing a metal body having an upper surface, where the body includes a layer of metal along the upper surface, and cutting the layer of metal via a single machining pass to simultaneously form a plurality of fins, with each fin having a body extending from the upper surface and terminating in a tip and where the plurality of fins are spaced from each other.

In yet another aspect, the present disclosure relates to an annular surface cooler for an aircraft engine which includes a metal body having an upper surface, a set of fluid passages extending through at least a portion of the depth of the metal body, and a plurality of fins cut into the upper surface, with each of the plurality of fins having a body and a laterally extending tip and where the body extends substantially along a width of the metal body.

### BRIEF DESCRIPTION OF THE DRAWINGS

In the drawings:

FIG. 1 illustrates a partially cutaway view of a turbine engine assembly with a surface cooler in accordance with various aspects described herein.

FIG. 2 is a perspective view of an aft portion of an exemplary fan casing in the turbine engine assembly of FIG. 1.

FIG. 3 is an exploded perspective view of the fan casing of FIG. 2.

FIG. 4 is an exemplary cross-sectional view of the surface cooler of the fan casing of FIG. 3.

FIG. 5 is a perspective view of a metal body of the surface cooler of FIG. 4 before and after the creation of a set of fins.

FIG. 6 is an axial cross-section view of the metal body of FIG. 5 during formation of a set of fins.

FIG. 7 is an axial cross-section view of the metal body of FIG. 6 having a set of fins in accordance with a first aspect of the disclosure wherein the set of fins have a square base.

FIG. 8 is an axial cross-section view of the metal body of FIG. 5 during formation of a set of fins.

FIG. 9 is an axial cross-section view of the metal body of FIG. 8 according to a second aspect of the disclosure wherein the set of fins have a curved base.

### DESCRIPTION OF EMBODIMENTS OF THE INVENTION

Aspects disclosed herein relate to surface coolers in an engine such as an aircraft engine. The exemplary surface coolers can be used for providing efficient cooling. Further, the term “surface coolers” as used herein can be used interchangeably with the term “heat exchangers.” As used herein, the surface coolers are applicable to various types of applications such as, but not limited to, turbojets, turbo fans, turbo propulsion engines, aircraft engines, gas turbines, steam turbines, wind turbines, water turbines and any additional environment where a heat exchanger can be utilized.

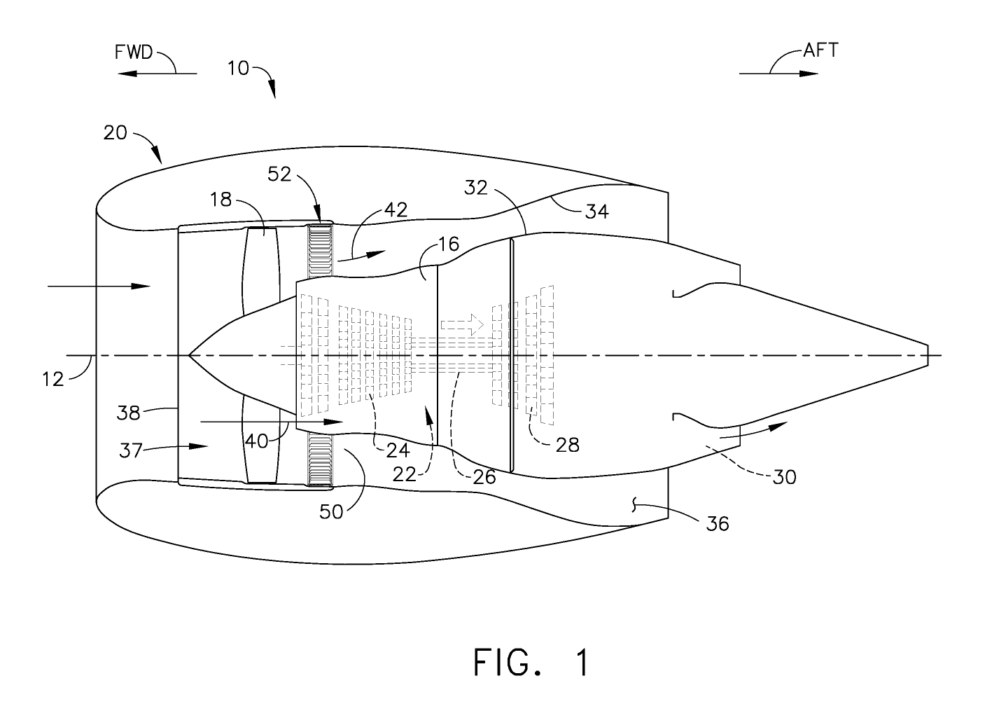

FIG. 1 illustrates an exemplary turbine engine assembly 10 having a longitudinal axis 12. A turbine engine 16, a fan assembly 18, and a nacelle 20 can be included in the turbine engine assembly 10. The turbine engine 16 can include an engine core 22 having at least one compressor 24, a combustion section 26, at least one turbine 28, and an exhaust 30. An inner cowl 32 radially surrounds the engine core 22.

Portions of the nacelle 20 have been cut away for clarity. The nacelle 20 surrounds the turbine engine 16 including the inner cowl 32. In this manner, the nacelle 20 forms an outer cowl 34 radially surrounding the inner cowl 32. The outer cowl 34 is spaced from the inner cowl 32 to form an annular passage 36 between the inner cowl 32 and the outer cowl 34. The annular passage 36 characterizes, forms, or otherwise defines a nozzle and a generally forward-to-aft bypass airflow path. A fan casing assembly 37 having an annular forward casing 38 and an annular aft casing 52 can form a portion of the outer cowl 34 formed by the nacelle 20 or can be suspended from portions of the nacelle 20 via struts (not shown).

In operation, air flows through the fan assembly 18 and a first portion 40 of the airflow is channeled through compressor(s) 24 wherein the airflow is further compressed and delivered to the combustion section 26. Hot products of combustion (not shown) from the combustion section 26 are utilized to drive turbine(s) 28 and thus produce engine thrust. The annular passage 36 is utilized to bypass a second portion 42 of the airflow discharged from fan assembly 18 around engine core 22.

The turbine engine assembly 10 can pose unique thermal management challenges and a heat exchanger or surface cooler, illustrated herein as an annular surface cooler 50, can be attached to the turbine engine assembly 10 to aid in the dissipation of heat.

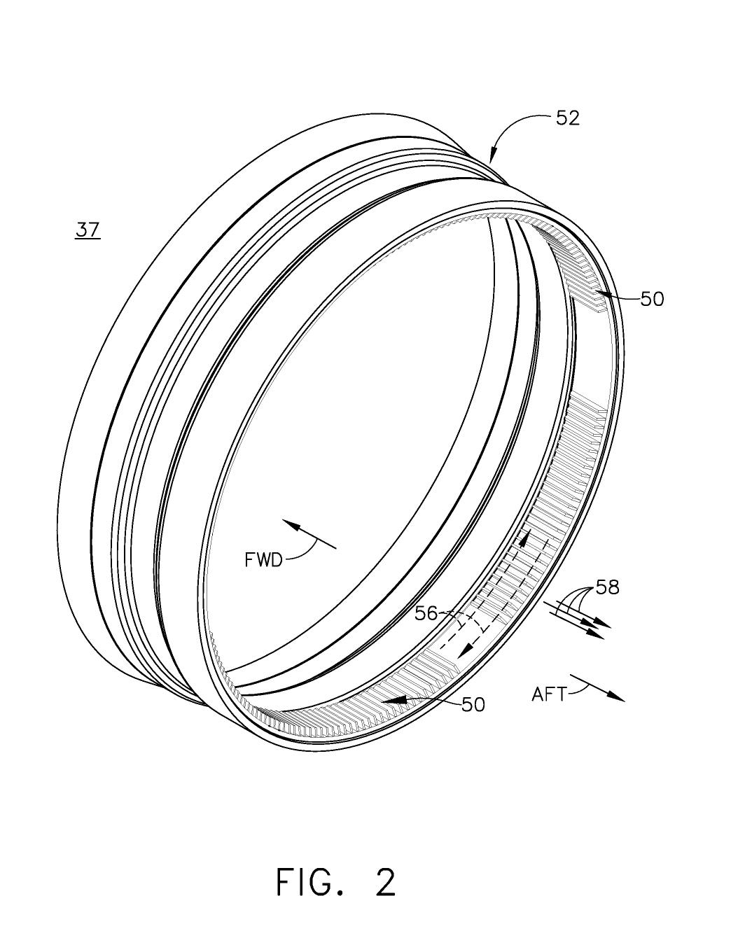

FIG. 2 illustrates an aft casing 52 of the fan casing assembly 37. The surface cooler 50 can be operably coupled to a peripheral wall 54 of the annular aft casing 52 and can include, but is not limited to, an air-cooled heat exchanger that is positioned within the annular passage 36 (FIG. 1). While the surface cooler 50 has been illustrated as being downstream of the fan assembly 18 (FIG. 1) it is also contemplated that the surface cooler 50 can alternatively be upstream from fan assembly 18. As such, it will be understood that the surface cooler 50 can be positioned anywhere along the axial length of the annular passage 36.

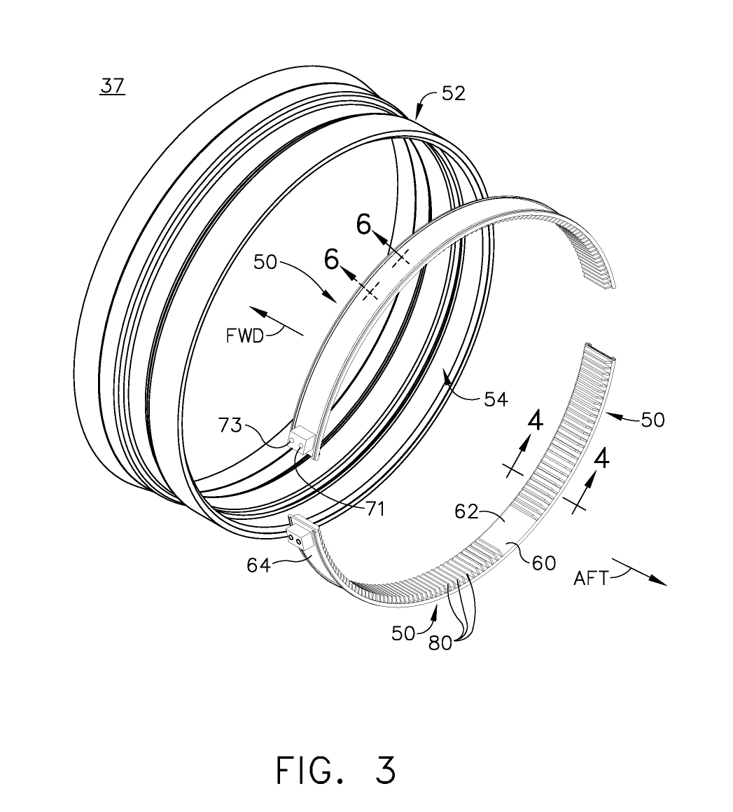

A partially exploded view of the aft casing 52 is shown in FIG. 3. The surface cooler 50 can include a circumferential and axial profile that is substantially similar to the circumferential and axial profile of the peripheral wall 54, and can cover any portion of the circumference of the peripheral wall 54. The annular surface cooler 50 can also include a metal body 60 having an upper surface 62 and a lower surface 64, as well as a set of fins 80 spaced circumferentially along the metal body 60. The lower surface 64 is configured to confront the peripheral wall 54 of the annular aft casing 52 when assembled. It will be understood that a set of surface coolers 50 can be utilized to cool a single turbine engine assembly 10, and also that “a set” as used herein can include any number including only one.

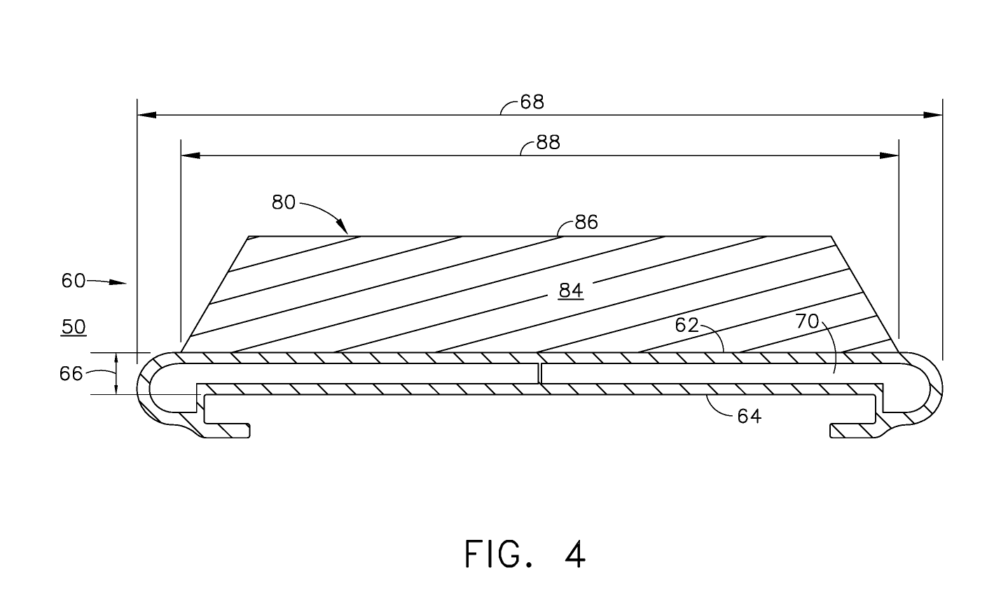

A circumferential cross-sectional view of the surface cooler 50, taken along the line 4-4, is shown in FIG. 4. The metal body 60 of the surface cooler 50 can further include an axial width 68, and the lower surface 64 can be spaced apart a depth 66 from the upper surface 62 as shown. A fin 80 of the surface cooler 50 can have a body 84 that extends radially from the upper surface 62 and terminates in a tip 86 which is unattached from the bulk of the surface cooler 50. The body 84 of the fin 80 can have a length 88 and extend substantially along the width 68 of the metal body 60 as shown. The surface cooler 50 can further include a set of circumferential internal fluid cooling passages 70 having an inlet 71 and outlet 73 and also extending through at least a portion of the depth 66 of the metal body 60. While the fluid passages 70 have been illustrated as square it will be understood that the passages can have any suitable shape, profile, or contour. In addition, the surface cooler 50 can be constructed such that a side 90 of a fin in the set of fins 80 can form a side angle 91 with a vertical reference line 92 as shown. It is also contemplated that either side of a fin in the set of fins 80 can form such an angle with respect to a vertical direction, and further, that the angles may be different between the two sides as desired. In addition, the surface cooler 50 can be constructed to create a different side angle for different fins in the set of fins 80.

Arrows 56 (FIG. 2) illustrate exemplary fluid flow through the surface cooler 50 and arrows 58 illustrate airflow that interacts with fins 80 during operation. Heat can be transferred from the fluid within through conduction to the remainder of the surface cooler 50 including the fins 80. Heat can then be dispersed via convection to the airflow 58.

A method of forming the fins 80 is illustrated in FIGS. 5-7. In FIG. 5, the metal body 60 is shown before and after the creation of the set of fins 80, and the metal body 60 is illustrated with a depth 66 and width 68 as shown. The depth 66 and width 68 can be any suitable depth and width depending on the configuration of the surface cooler 50. While the metal body 60 has been illustrated as straight and rectangular it will be understood that this is for clarity purposes only and that the metal body 60 can be curved and contain any of the features used for mounting of the surface cooler 50.

In one non-limiting example, the metal body 60 and fluid cooling passages 70 can be formed by an extrusion process. In such an instance an additional metal portion 75 can also be extruded onto the upper surface 62 of the metal body 60. It is contemplated that the metal body 60 and additional metal portion 75 can include an aluminum-based alloy such as 3000 aluminum alloy or 6000 aluminum alloy; however, this example is not intended to be limiting, and any material suitable for the fan casing environment is contemplated for the metal body 60 and additional portion 75. It is further contemplated that the metal body 60 and additional metal portion 75 may be made from the same material, or the metal body 60 may be made from a different material from the additional metal portion 75, having different hardnesses or thermal properties suited for the intended location of the surface cooler 50.

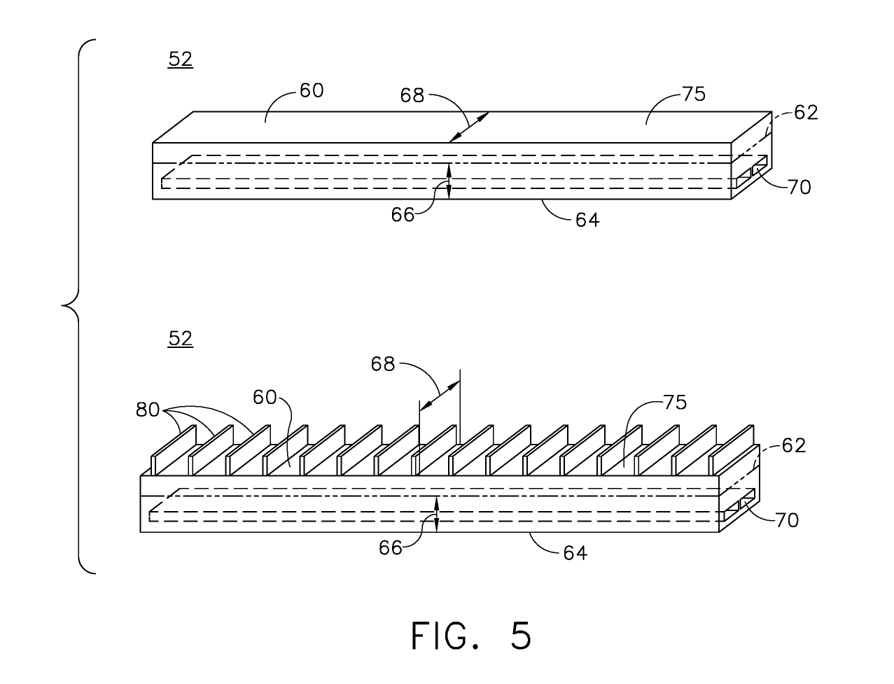

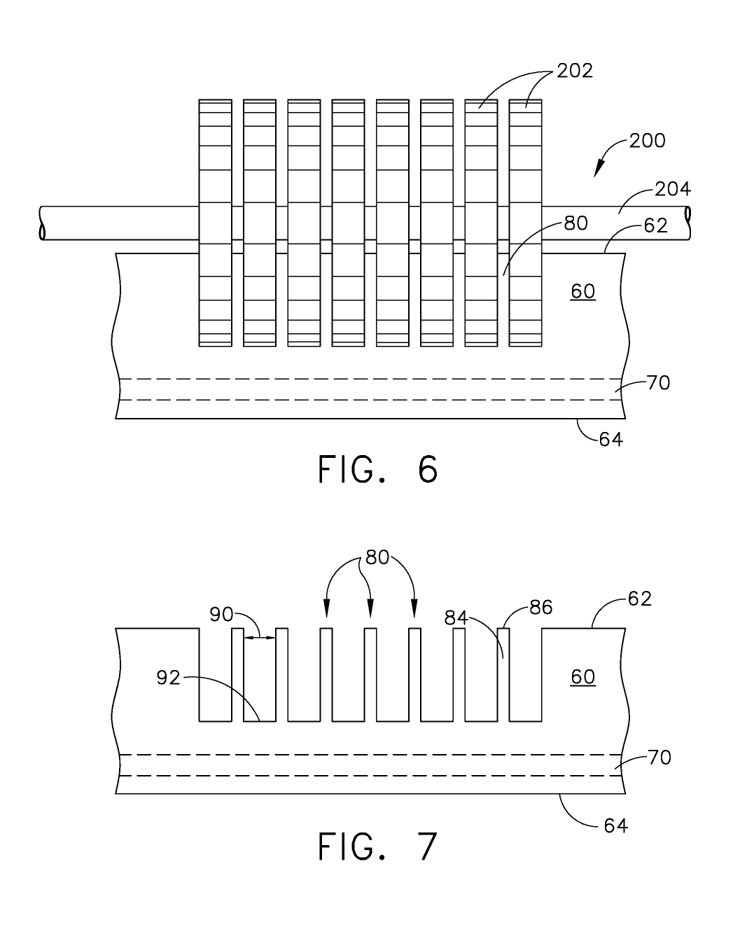

A stacked slit saw 200 having a set of saw blades 202 attached to a horizontal mill 204 can be used to create the fins 80 in the additional portion of metal 75 according to a first aspect of the disclosure as shown in FIG. 6, which is an axial cross-sectional view taken along the line 6-6 (FIG. 3). It should be understood that the saw blades 202 may be attached to any machine or assembly having a rotating shaft, including, but not limited to, the horizontal mill 204. During a single pass of the stacked slit saw 200, the set of saw blades 202 can advance into and through the metal body 60 to cut and form the set of fins 80 in a layer of metal near the upper surface 62 and spaced apart from the fluid cooling passages 70. The saw blades 202 can have a square profile and provide support against vibration or other disturbances to the fins 80 during the formation process; after forming the fins 80, the saw blades 202 may be removed from the metal body 60. It can be appreciated that in order to form additional fins, the metal body 60 may be shifted with respect to the saw blades 202 in order to present an un-cut portion toward the saw blades 202. It can be advantageous to control the rate of motion of the metal body 60 (also called the feed rate) as well as the rotational speed of the stacked slit saw 200, and the feed rate can also be tailored to the material used in the metal body 60, the height of the fins 80, the number of fins 80 created per unit length of the metal body 60, or the number of fins 80 created per pass of the saw blades 202. It will be understood that fins on a heat exchanger that is larger than a foot, including a heat exchanger greater than five feet in length can be created quickly using the method disclosed herein. It can be appreciated that the stacked slit saw 200 can be operably coupled to a controller (not shown) in order to control the rate of saw advancement, rotational speed, feed rate, and other operational parameters relevant to the creation of the fins 80.

A completed set of fins 80 are illustrated in FIG. 7. Each fin 80 can be formed perpendicular to the upper surface 62, and one fin 80 can be spaced apart by a distance 90 from an adjacent fin 80. In addition, a base 92 can be formed between the lower portions of adjacent fins 80. The base 92 can have a substantially square profile as shown although it will be understood that other shapes, profiles, or contours can alternatively be created. It will be understood that the fins 80 can be formed at any suitable angle including, but not limited to, an angle other than 90 degrees with the upper surface 62. Further, while fins have been illustrated along only a portion of the length of the section of the heat exchanger it will be understood that the entire upper surface 62 can include fins 80.

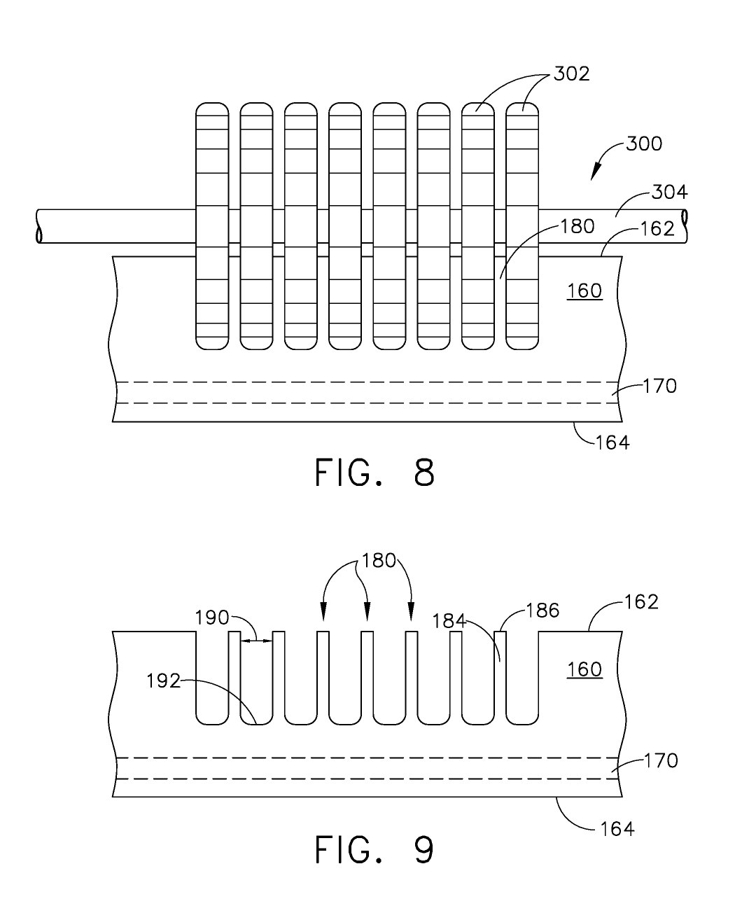

FIGS. 8 and 9 illustrate the formation of fins according to a second aspect of the disclosure. The second aspect is similar to the first aspect; therefore, like parts will be identified with like numerals increased by 100, with it being understood that the description of the like parts of the first aspect applies to the second aspect, unless otherwise noted. A stacked slit saw 300 having a set of saw blades 302 attached to a horizontal mill 304 can be used to create a set of fins 180, and the saw blades 302 can have a rounded profile as shown in FIG. 8. It is also contemplated that the saw blades 302 can be chamfered, circular, or any other suitable geometry to create the set of fins 180 with a desired profile. After formation, a fin in the set of fins 180 can have a rounded base 192 as shown in FIG. 9, and adjacent fins 180 can be spaced apart a distance 190.

During operation of the surface cooler 50 (FIG. 1) a hot fluid such as heated air or oil can be passed through the fluid cooling passages 70, proximal to the upper surface 62. Heat from the fluid may be conducted through the metal body 60 and can be dissipated through the set of fins 80 to a cooling fluid passing by the fins 80. The cooling fluid can include, but is not limited to, cooling air passing through the annular passage 36, which by way of a non-limiting example can be a bypass duct of the turbine engine 10.

The above described embodiments provide for a variety of benefits including increased fin durability, faster rates of fin formation, and the ability to create thinner fins compared to other methods of manufacturing. In addition, surface coolers having fins integrally formed from parent material such as the metal body can have a higher heat transfer coefficient compared to surface coolers having fins coupled to the parent material by various known attachment mechanisms, and it can be appreciated that the embodiments described above can provide for the more efficient manufacture of surface coolers having integrally-formed fins with better cooling ability. Further, the above described embodiments and methods of formation may be more affordable, repeatable, and more reliable which allows for predictable fin geometry at predictable spacing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method of forming multiple fins in a heat exchanger, the method comprising:
providing a metal body having an upper surface and where the metal body includes fluid cooling passages and a layer of metal along the upper surface and spaced from the fluid cooling passages; and
cutting the layer of metal to simultaneously form a plurality of fins, with each fin having a body extending from the upper surface and terminating in a tip.

2. The method of claim 1 wherein the body extends substantially along a width of the metal body.

3. The method of claim 1 wherein simultaneously forming the plurality of fins comprises creating the plurality of fins with a single machining pass.

4. The method of claim 3 wherein the single machining pass is accomplished via a single advancing motion of a stacked slit slaw along a lengthwise direction of the metal body.

5. The method of claim 4 wherein the stacked slit saw comprises stacked slit saw blades in a horizontal mill.

6. The method of claim 5 wherein the stacked slit saw blades provide support to the plurality of fins during the single machining pass.

7. The method of claim 4 wherein cutting the layer of metal to simultaneously form a plurality of fins comprises controlling a feed rate of the metal body and a rotational speed of the stacked slit saw.

8. The method of claim 3 wherein the single machining pass is over a section of the heat exchanger that is more than five feet in length.

9. The method of claim 3 wherein the single machining pass creates a plurality of fins that are completely spaced from each other.

10. The method of claim 9 wherein a space between two adjacent of the plurality of fins comprises a square base.

11. The method of claim 3 wherein the plurality of fins are at a 90 degree angle with respect to the upper surface.

12. The method of claim 3 wherein providing the metal body comprises extruding the metal body and fluid cooling passages.

13. The method of claim 12 wherein the metal body is formed from an aluminum alloy material.

14. A method of forming multiple fins in a portion of a surface cooler for an aircraft engine, the method comprising:
providing a metal body having an upper surface and where the body includes a layer of metal along the upper surface; and
cutting the layer of metal, via a single machining pass, to simultaneously form a plurality of fins, with each fin having a body extending from the upper surface and terminating in a tip and where the plurality of fins are spaced from each other.

15. The method of claim 14 wherein the metal body comprises a cast manifold of the surface cooler.

16. The method of claim 14 wherein the metal body comprises an extruded heat exchanger section of the surface cooler.

17. The method of claim 14 wherein the single machining pass is accomplished via a single advancing motion of a stacked slit slaw along a width of the body.

18. The method of claim 14 wherein a space between two adjacent of the plurality of fins comprises a square base.

19. An annular surface cooler for an aircraft engine, comprising:
a metal body having an upper surface;
a set of fluid passages extending through at least a portion of a depth of the metal body; and
a plurality of fins cut into the upper surface, with each of the plurality of fins having a body and a laterally extending tip and where the body extends substantially along a width of the metal body.

20. The annular surface cooler of claim 19 wherein the metal body comprises an aluminum-based alloy body.
